(19) United States
(12) Patent Application Publication
(10) Pub. No.: US 2016/0056479 A1
(43) Pub. Date: Feb. 25, 2016

(54) TITANIUM SHEET MATERIAL FOR FUEL CELL SEPARATORS AND METHOD FOR PRODUCING SAME

(71) Applicant: KABUSHIKI KAISHA KOBE SEIKO SHO(KOBE STEEL, LTD.), Kobe-shi, Hyogo (JP)

(72) Inventors: Yoshio ITSUMI, Takasage-shi (JP); Hideto OYAMA, Takasage-shi (JP); Yasushi MAEDA, Kobe-shi (JP); Daisuke HAYASHI, Kakogawa-shi (JP); Jun SUZUKI, Kobe-shi (JP)

(73) Assignee: KABUSHIKI KAISHA KOBE SEIKO SHO(KOBE STEEL, LTD.), Kobe-shi, Hyogo (JP)

(21) Appl. No.: 14/778,968

(22) PCT Filed: Mar. 13, 2014
(86) PCT No.: PCT/JP2014/056626

§ 371 Date: Sep. 21, 2015

(30) Foreign Application Priority Data
Mar. 27, 2013 (JP) 2013-067376

(51) Int. Cl. H01M 8/02; C22F 1/18; C22F 1/02

(52) U.S. Cl. CPC H01M 8/0206; C22F 1/02; C22F 1/183

(57) ABSTRACT

Provided is a titanium sheet for fuel cell separators which can surely achieve a low contact resistance. This titanium sheet for fuel cell separators includes a titanium base metal and a surface layer. The titanium base metal has a recrystallized structure. The surface layer includes a compound-mixed titanium layer having thickness less than 1 μm alone. The compound-mixed titanium layer includes a mixture of matrix titanium (Ti) and a compound between Ti and at least one element selected from the group consisting of oxygen (O), carbon (C), and nitrogen (N). The matrix titanium contains O, C, and N each solid-soluted in the titanium. Alternatively, the surface layer includes the compound-mixed titanium layer and a passivation layer being disposed on a surface of the compound-mixed titanium layer and having a thickness less than 5 nm.

### TECHNICAL FIELD

The present invention relates to a titanium sheet that has a low contact resistance and is useful typically for fuel cell separators. The separators are usable typically in polymer electrolyte fuel cells (PEFCs).

### BACKGROUND ART

Fuel cells can give continuous electric power by continuously supplying a fuel (e.g., hydrogen) and an oxidant (e.g., oxygen), unlike primary cells such as dry cells; and secondary cells such as lead storage batteries. The fuel cells have high generation efficiency and can be applied to various system sizes. In addition, the fuel cells do not generate noise and vibration. The fuel cells are therefore promising as energy sources covering a variety of applications. Recently many types of fuel cells have been developed as polymer electrolyte fuel cells (PEFCs), alkaline fuel cells (AFCs), phosphoric acid fuel cells (PAFCs), molten carbonate fuel cells (MCFCs), solid oxide fuel cells (SOFCs), and biofuel cells. Among them, PEFCs have been developed for use in fuel-cell-powered automobiles; in residential co-generation systems; and for mobile devices such as cellular phones and personal computers.

Such a PEFC is hereinafter simply referred to as a “fuel cell”. The fuel cell includes a stack of a plurality of unit cells including an anode, and a cathode, and a polymer electrolyte membrane. The polymer electrolyte membrane is put between the anode and the cathode, each. The separators are electroconductive materials provided with grooves as gas flow channels for a gas such as hydrogen or oxygen. The separators are also called bipolar plates. The fuel cell can have a higher output by increasing the number of cells per stack.

The fuel cell separators also act as a cell that generates current from the fuel cell to the outside and are thereby demanded to have a low contact resistance. The contact resistance refers to an electric resistance that is generated at an interface between the electrode and the separator surface. The fuel cell separators are also demanded to maintain the low contact resistance during long-term operation of the fuel cell. In addition, the inside of the fuel cell is in a high-temperature and acidic atmosphere, and the fuel cell separators are demanded to maintain a high electroconductivity over a long time even in such atmosphere. A proposed technique to achieve electroconductivity and corrosion resistance both at satisfactory levels is a metallic foil separator. The metallic foil separator has a surface layer structure obtained by forming an electroconductive layer on a base metal, or by covering a substance acting as a conduction path with an oxide film while dispersing the substance.

Titanium has excellent corrosion resistance and is considered as a potent candidate as a material for metal separators. Titanium ensures the corrosion resistance by the action of a passivation layer, where the passivation layer is formed on the surface layer of titanium and has a small thickness of about 10 nm to about 20 nm. On the other hand, the passivation layer also acts as an insulating film and, even when mechanically removed, is easily formed again upon exposure to the air even at room temperature. For this reason, titanium is not always sufficient as a material for metal separators from the viewpoint of providing a titanium material that maintains a stably low contact resistance.

As a technique for stably reducing such a passivation layer, Patent Literature (PTL) 1 and Non Patent Literature (NPL) 1 each disclose techniques of forming a layer typically of a noble metal on the passivation layer, then performing a vacuum heat treatment so as to cause the passivation layer to have a smaller thickness and to be converted from an amorphous state into a rutile oxide state. The rutile oxide acts as an n-type semiconductor and more contributes to better electroconductivity as compared with the amorphous oxide. These techniques provide better electroconductivity by forming the noble metal layer and then performing the heat treatment. The techniques, however, often cause unevenness in thickness of the passivation layer. The thickness of the passivation layer on the titanium base metal significantly affects the magnitude of contact resistance and, if being uneven, causes the separator as a final product to suffer from unevenness in electroconductivity.

### CITATION LIST

### Patent Literature

PTL 1: Japanese Unexamined Patent Application Publication (JP-A) No. 2009-123528

### Non Patent Literature

NPL 1: SATOH et al. (another one), “Improvement in Electrical Conductivity of Titanium Separator with Au Coating through Heat Treatment”, Research and Development, Kobe Steel Engineering Reports, Kabushiki Kaisha Kobe Seiko Sho (Kobe Steel, Ltd.), vol. 60, No. 2, pp. 29-32 (August, 2010).

### SUMMARY OF INVENTION

### Technical Problem

The present invention has been made while focusing on the circumstances and has an object to provide a titanium sheet for fuel cell separators, where the titanium sheet can surely achieve a low contact resistance; and to provide a separator obtained using the titanium sheet.

### Solution to Problem

The present invention can achieve the object and provides a titanium sheet for fuel cell separators. The titanium sheet includes a titanium base metal and a surface layer. The titanium base metal has a recrystallized structure. The surface layer includes a compound-mixed titanium layer having thickness less than 1 μm alone. The compound-mixed titanium layer includes a mixture of matrix titanium (Ti) and a compound, where the matrix titanium contains oxygen (O), carbon (C), and nitrogen (N) each solid-soluted in the titanium. The compound is formed between Ti and at least one element selected from the group consisting of O, C, and N. Alternatively, the surface layer includes the compound-mixed titanium layer, and a passivation layer being disposed on a surface of the compound-mixed titanium layer and having a thickness less than 5 nm. The titanium sheet preferably has a thickness from 0.02 to 0.4 mm. The compound-mixed titanium layer preferably has a thickness of 10 nm or more. The titanium sheet according to the present invention may have a contact resistance of typically 20.0 mg·cm² or less.

The titanium sheet can be produced by cold-rolling an annealed titanium sheet stock using an organic rolling oil to give a cold-rolled workpiece and subjecting the cold-rolled workpiece to a heat treatment. The cold rolling has a single- or multi-stage pass schedule including one or more rolling passes meeting a condition as specified by Formula (1). The rolling pass meeting the condition is also referred to as a “passivation-layer-breakdown pass”. The total rolling reduction R of all the passivation-layer-breakdown passes as calculated by Formula (2) is 25% or more. Formulae (1) and (2) are expressed as follows:

L≧−20/D+1.35 (1)

where L represents the length (mm) of a contact portion between a rolling work roll and the titanium workpiece to be rolled; and D represents the diameter (mm) of the rolling work roll,

R=(1−tₐ₁/t_{b1}×ta₂/t_{b2}×tₐ₃/t_{b3} . . . )×100 (2)

where tₐ₁ and t_{b1} represent sheet thicknesses respectively after and before rolling of a first passivation-layer-breakdown pass; tₐ₂ and t_{b2} represent sheet thicknesses respectively after and before rolling of a second passivation-layer-breakdown pass; and tₐ₃ and t_{b3} represent sheet thicknesses respectively after and before rolling of a third passivation-layer-breakdown pass, where the term of tₐₙ/t_{bn} (where n is an integer) in Formula (2) is repeated in a number n of the passivation-layer-breakdown pass(es), the term of tₐₙ/t_{bn} in Formula (2) is present in a number of 1 or 2 respectively when the cold rolling comprises one or two passivation-layer-breakdown passes, and where the cold rolling does not have to comprise individual passivation-layer-breakdown passes successively and may comprise one or more rolling passes not meeting the condition specified by Formula (1) between passivation-layer-breakdown passes. In the heat treatment, it is necessary that the cold-rolled workpiece is heated at a temperature of from 400° C. to 870° C. in an inert gas or in a vacuum to undergo recrystallization and then cooled down to a temperature of 300° C. or lower before being exposed to the air.

The present invention also includes a fuel cell separator that includes the titanium sheet as a base metal, and an electroconductive layer on a surface of the base metal.

### Advantageous Effects of Invention

The titanium sheet for fuel cell separators according to the present invention bears the specific titanium layer featured by existence forms of O, C, and N on the surface so as to appropriately breakdown a passivation layer and to restrain the passivation layer from regenerating. The titanium sheet can therefore have a remarkably reduced contact resistance because of stable and significant reduction in thickness of the passivation layer.

### BRIEF DESCRIPTION OF DRAWINGS

FIG. 1 is a conceptual diagram of rolling for illustrating a contact arc length in the present invention;

FIG. 2a is a first graph for illustrating constitute grounds for the rolling pass design concept in the present invention;

FIG. 2b is a second graph for illustrating constitute grounds for the rolling pass design concept in the present invention;

FIG. 3 is a schematic diagram illustrating contact resistance measurement equipment;

FIG. 4 is a low-magnification transmission electron photomicrograph of a titanium sheet in the surface layer portion;

FIG. 5 is a medium-magnification transmission electron photomicrograph of the titanium sheet in the surface layer portion; and

FIG. 6 is a high-magnification transmission electron photomicrograph of the titanium sheet in the surface layer portion.

### DESCRIPTION OF EMBODIMENTS

The present inventors made intensive investigations so as to stably reduce the passivation layer, and, during the process of the investigations, found that there are such rolling conditions as to break down the passivation layer appropriately and as to form a compound-mixed titanium layer on the surface, where the compound-mixed titanium layer refers to a specific titanium layer that is featured by existence forms of O, C, and N. The compound-mixed titanium layer is a layer in which a compound between titanium (Ti) and at least one element selected from the group consisting of O, C, and N is mixed with (in particular dispersed in) Ti matrix containing solid-soluted (solute) O, C, and N. This will be illustrated below while taking TiC as an example of the compound. When the compound-mixed titanium layer as above is formed on the surface, carbon in the carbide (TiC) or solid-soluted carbon binds to titanium before oxygen in the air binds to titanium. This causes titanium in the surface layer to be resistant to reaction with oxygen in the air and thereby restrains the passivation layer from regenerating. Specifically, the present inventors found that this technique successfully attains both the breakdown and prevention of regeneration of the passivation layer so as to stably reduce the passivation layer. The present invention has been made based on these findings.

Specifically, the titanium sheet according to the present invention includes a titanium base metal and a surface layer, where the surface layer includes the compound-mixed titanium layer. The compound-mixed titanium layer may bear a passivation layer (titanium oxide layer) on a surface (referring to a side opposite to the titanium base metal), or not. The passivation layer, even when existing, has a thickness less than 5 nm. The titanium sheet can have a significantly low contact resistance because the passivation layer having a high resistance is significantly restrained. The passivation layer has a thickness of preferably 3 nm or less, and more preferably 1 nm or less. The thickness of the passivation layer may be an average of measured values upon measurement at two or more points.

The compound-mixed titanium layer is a layer in which a compound between Ti and at least one (e.g., at least two, and particularly three) element selected from the group consisting of O, C, and N is mixed with matrix Ti containing solid-soluted O, C, and N, as mentioned above. In a preferred embodiment, titanium carbide is mixed with matrix titanium containing solid-soluted carbon. In this preferred embodiment, O and/or N may be solid-soluted in titanium in addition to carbon, and/or, the titanium carbide may further contain oxygen and/or nitrogen. Such compound-mixed titanium layer has high electroconductivity, and the layer by itself is not liable to cause a higher contact resistance. The compound-mixed titanium layer, when formed, resists the formation of a passivation layer on the surface thereof. The compound-mixed titanium layer may have a thickness of 10 nm or more, typically 30 nm or more, and preferably 50 nm or more. The compound-mixed titanium layer, if having an excessively large thickness, may suffer from cracking upon press forming, because the layer is rigid. To prevent this, the compound-mixed titanium layer may have a thickness of 1 μm or less, preferably 500 nm or less, and more preferably 300 nm or less.

The titanium base metal is a layer that includes metal titanium and has a recrystallized structure. The base metal itself has a lower electric resistance because of having the recrystallized structure and contributes to a lower contact resistance of the titanium sheet. The recrystallized structure preferably constitutes the entire titanium base metal, but may constitute a part of the layer. The recrystallized structure, even when constituting a part of the base metal, ensures conduction in the part and contributes to a lower contact resistance of the titanium sheet.

The titanium base metal may be made of a material being either of pure titanium and a titanium alloy. The material usable herein is exemplified by pure titanium of Grade 1 to Grade 4 as prescribed in Japanese Industrial Standard (JIS) H 4600; and titanium alloys such as Ti—Al alloys, Ti—Ta alloys, Ti-6Al-4V alloys, and Ti—Pd alloys. Of the materials, preferred is pure titanium.

The titanium sheet according to the present invention has a low contact resistance because of stable, significant restrainment of the passivation layer, as described above. The titanium material has a contact resistance of typically 20.0 mΩ·cm² or less, preferably 10 mg·cm² or less, and more preferably 5 mΩ·cm² or less. The contact resistance is a finite value (positive value) at room temperature, and the lower the contact resistance is, the better.

The titanium sheet according to the present invention may have a thickness of typically 0.02 mm or more, preferably 0.05 mm or more, and more preferably 0.08 mm or more, in terms of lower limit of the thickness appropriate as a cell separator. The titanium sheet according to the present invention may have a thickness of typically 0.4 mm or less, preferably 0.3 mm or less, and more preferably 0.2 mm or less in terms of upper limit of the thickness appropriate as a cell separator.

The titanium sheet can be produced by subjecting a titanium sheet stock (foil, annealed material) sequentially to cold rolling and to a heat treatment under predetermined conditions. Initially, the cold rolling affects the breakdown of the passivation layer present before rolling and the formation of the compound-mixed titanium layer. This will be described in detail below.

First, the passivation layer is broken down by the rolling-reduction action, and is elongated and becomes thinner by the stretching action upon the cold rolling. In contrast, the rolling oil is entangled at the contact portion between the titanium surface and the roll surface while causing galling. This causes C contained in the organic rolling oil and O constituting the passivation layer to be forcedly solid-soluted in an outermost layer of the titanium sheet stock. In addition, carbon reacts with titanium in the outermost layer to form a TiC-based compound. Accordingly, a compound-mixed titanium layer is formed in the outermost layer. The compound-mixed titanium layer is a film or layer including such TiC-based compound and fine alpha-phase titanium having a size on the order of submicrons and containing solid-soluted carbon. The present inventors found that the rolling may be performed under such conditions as to give a positive amount of change (Δ(C/O)) of the ratio (C/O) of the carbon concentration to the oxygen concentration before and after a rolling pass. This is performed so as to appropriately break down the originally-existing passivation layer, to stably form the compound-mixed titanium layer, and to thereby surely restrain the regeneration of the passivation layer. The carbon concentration and oxygen concentration in the outermost layer are determined by performing measurement of elements Ti, C, and O with an electron probe micro-analyser (EPMA), and determining the concentrations of the individual elements in atomic percent.

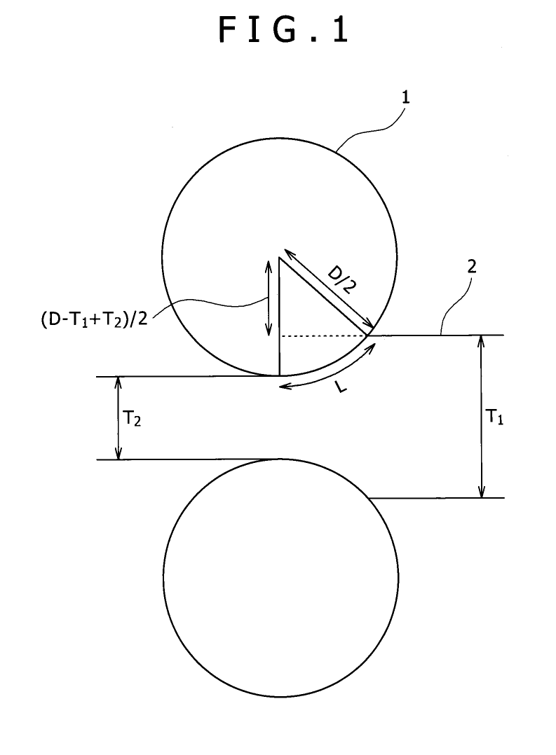

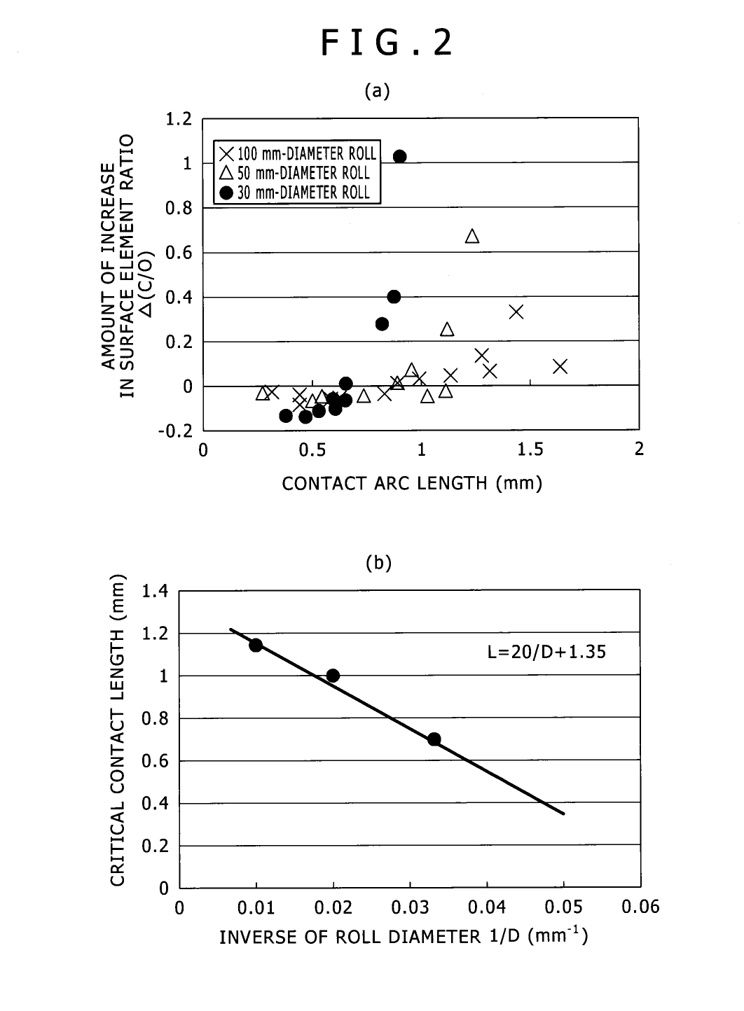

The present inventors also made experiments of rolling employing different pass schedules and different roll diameters. As a result, they found that the amount of change Δ(C/O) tended to be larger with an increasing contact arc length, where the contact arc length refers to the length of a contact portion between the titanium surface and the roll surface. FIG. 1 is a conceptual diagram of rolling for explaining the contact arc length; and FIG. 2a is a graph illustrating how the amount of change Δ(C/O) varies depending on the contact arc length.

As illustrated in FIG. 1, a titanium workpiece 2 having a thickness T₁ is rolled into a thickness T₂ with a pair of work rolls 1 each having a diameter D. The contact arc length L is the length of a contact portion between the work roll 1 and the titanium workpiece 2 and is a value specified by the formula: L=D/2×a cos(1−(T₁−T₂)/D).

FIG. 2a is a graph illustrating how the contact arc length upon rolling varies depending on the amount of change Δ(C/O). The graph includes data of three systems, i.e., data on rolling with work rolls each having a diameter of 100 mm; rolling with work rolls each having a diameter of 50 mm; and rolling with work rolls each having a diameter of 30 mm. The graph demonstrates that, in any system, the amount of change Δ(C/O) is a negative constant value at small contact arc lengths, but rises and runs through the zero level up to positive values at contact arc lengths of a certain level or more. This is probably because, at a long contact arc length, the rolling causes a large amount of carbon to be entangled to form a compound-mixed titanium layer, whereas the passivation layer is to be broken down by the stretching (formation of a newly-formed surface) and slip between the rolls and the workpiece (shear fracture of the passivation layer). For example, in the rolling using rolls having a diameter of 30 mm, the amount of change Δ(C/O) becomes positive at a contact arc length of 0.7 mm or more, and the passivation layer breakdown and the compound-mixed titanium layer formation proceed. In contrast, the amount of change Δ(C/O) becomes negative at a short contact arc length. Specifically, the amount of change Δ(C/O) is negative at a contact arc length of 0.7 mm or less, and the passivation layer breakdown and the compound-mixed titanium layer formation do not occur. The present inventors examined on tendency at different roll diameters, plotted a minimum contact arc length (critical contact length) at which the amount of change Δ(C/O) is positive versus the inverse (1/D) of the roll diameter (FIG. 2b), and obtained Formula (1):

L≧−20/D+1.35 (1)

where L represents the contact arc length (mm); and D represents the diameter (mm) of each rolling work roll.

A rolling pass meeting the condition specified by Formula (1) is hereinafter also referred to as a “passivation-layer-breakdown pass”. To eventually break down a sufficient amount of the passivation layer and to form the compound-mixed titanium layer appropriately, it is necessary that the rolling is performed in a single-stage or multistage pass schedule including one or more passivation-layer-breakdown passes, and that the total rolling reduction R of all the passivation-layer-breakdown passes is 25% or more. The term “total rolling reduction R” refers to the ratio of the rolling reduction of the passivation-layer-breakdown pass(es) to the thickness of the sheet (titanium sheet stock) before the start of all rolling passes. Specifically, the total rolling reduction R can be calculated according to Formula (2):

R=(1−tₐ₁/t_{b1}×tₐ₂/t_{b2}×tₐ₃/t_{b3} . . . )×100 (2)

where tₐ₁ and t_{b1} represent sheet thicknesses respectively after and before rolling of a first passivation-layer-breakdown pass; tₐ₂ and t_{b2} represent sheet thicknesses respectively after and before rolling of a second passivation-layer-breakdown pass; and Wand ti represent sheet thicknesses respectively after and before rolling of a third passivation-layer-breakdown pass. The term of tₐₙ/t_{bn}. (where n is an integer) in Formula (2) is repeated in a number n of the passivation-layer-breakdown pass(es), where the term of tₐₙ/t_{bn}, in Formula (2) is present in a number of 1 or 2 respectively when the cold rolling includes one or two passivation-layer-breakdown passes. The rolling pass schedule desirably includes individual passivation-layer-breakdown passes successively, but may not. For example, the rolling pass schedule may include one or more rolling passes not meeting the condition specified by Formula (1) interposed between adjacent passivation-layer-breakdown passes.

The total rolling reduction R of all the passivation-layer-breakdown pass(es) is preferably 30% or more, and more preferably 40% or more. In consideration of the rolling limit of the material, the total rolling reduction R of the passivation-layer-breakdown pass(es) may be, for example, 90% or less. A rolling pass excluding the passivation-layer-breakdown passes is hereinafter also referred to as a “non-breakdown pass”. In the non-breakdown pass, the compound-mixed titanium layer may be stripped off by the rolls and may thereby become thinner. Even in this case, the proportion of the non-breakdown pass is reduced by controlling the total rolling reduction R of the passivation-layer-breakdown pass(es) within the range, and this allows the compound-mixed titanium layer to remain appropriately.

The rolling reduction Rt of all passes in the cold rolling is typically 25% or more, preferably 40% or more, and more preferably 50% or more, where Rt is specified by the formula: Rt=(Hs·Hg)/Hs, where Hg represents the sheet thickness after the completion of all the rolling passes; and Hs represents the sheet thickness of the titanium sheet stock before rolling in a first rolling pass. The proportion of the total rolling reduction R of the passivation-layer-breakdown pass(es) may be typically 40% or more, preferably 70% or more, and may also be 100%, of the rolling reduction Rt of all the passes.

The cold rolling may be performed at a rate of typically 50 m/min or more, and desirably 100 m/min or more from the viewpoint of productivity.

The cold rolling of the titanium sheet stock to produce the titanium sheet is often performed typically using a reverse rolling mill.

The rolling oil for use in the cold rolling is not limited, as long as being an carbon-containing oil such as an organic rolling oil, and is exemplified by mineral oils such as neat oils; synthetic oils such as ester oils; and fats and fatty oils.

Control of the total rolling reduction R of the passivation-layer-breakdown pass(es) meeting the condition specified by Formula (1) to 25% or more as above enables the passivation layer breakdown, the compound-mixed titanium layer formation, and the passivation layer regeneration restrainment. The rolled workpiece obtained in the above manner, when subjected to intermediate anneal under predetermined heat treatment conditions, allows the titanium base metal portion to include a recrystallized structure and yields the titanium sheet according to the present invention.

Specifically, the intermediate anneal is performed in an inert gas or in a vacuum. This is performed for preventing a titanium oxide layer (passivation layer) from forming during the intermediate anneal. The inert gas is typically preferably argon gas. The inert gas has a dew point of preferably −30° C. or lower, more preferably −40° C. or lower, and furthermore preferably −50° C. or lower. The lower dew point the inert gas has, the better. The heat treatment, when performed in a vacuum, may be performed at an absolute pressure of typically 0.01 Pa or less, and preferably 0.001 Pa or less while reducing the oxygen concentration (evacuation). Alternatively, the heat treatment may be performed in an inert gas atmosphere by performing the evacuation and thereafter charging an inert gas such as argon (Ar) or helium (He) gas into the system to a pressure lower than the atmospheric pressure.

The intermediate anneal may be performed at a heating temperature of 400° C. to 870° C. The intermediate anneal, if performed at a heating temperature of lower than 400° C., may fail to allow the titanium base metal after rolling to undergo recovery/recrystallization, may fail to allow the material itself to have sufficiently better resistance, and may fail to induce processability recovery. The heating temperature is preferably 450° C. or higher, and more preferably 500° C. or higher. In contrast, the intermediate anneal, if performed at a heating temperature higher than the beta transformation temperature around 890° C., may cause the formation of a beta phase. The beta phase readily allows oxygen atom to migrate thereinto, and this may cause a passivation layer to grow by the presence of oxygen existing in a trace amount in the furnace. In addition, such intermediate anneal may also cause the microstructure to excessively coarsen and may induce orange peel surfaces and/or cracking upon forming. To prevent these, the heating temperature may be controlled to 870° C. or lower, preferably 800° C. or lower, and more preferably 750° C. or lower.

The heating may be performed for such a time as to ensure a necessary time for recrystallization, where the necessary time may vary depending on the heating temperature. For example, assume that an intermediate anneal at a high temperature of 700° C. is performed on a workpiece having a sheet thickness of 0.1 mm. In this case, the heating for a holding time of one minute is sufficient for the workpiece to have a recrystallized structure. Also assume that an intermediate anneal at a temperature of 500° C. is performed on the workpiece. In this case, the heating for a holding time of one hour is enough for the workpiece to surely have a recrystallized structure.

After the completion of the heating, the annealed workpiece has to be cooled down to a temperature of 300° C. or lower before being exposed to the air. Titanium is susceptible to oxidation, but, when exposed to the air at a temperature (temperature at which the workpiece is retrieved from the annealing furnace) controlled to 300° C. or lower, can resist the oxide layer regeneration in the surface layer. The temperature at which the workpiece is exposed to the air is preferably 200° C. or lower, and more preferably 100° C. or lower. The temperature at which the workpiece is exposed to the air is not critical on its lower limit, but is generally 0° C. or higher, and typically room temperature or higher.

The titanium sheet stock for use as a raw material in the old rolling and heat treatment can be produced according to a common method. For example, the titanium sheet stock can be produced by subjecting an ingot of pure titanium or a titanium alloy sequentially to bloom forging, hot rolling, and cold rolling. This cold rolling is hereinafter also referred to as “preliminary cold rolling” so as to be distinguished from cold rolling of the titanium sheet stock. The method may further include annealing and/or descaling treatment (e.g., acid wash) as appropriate in a process after the hot rolling and before the preliminary cold rolling. The method may further include one or more of annealing, salt bath immersion, and acid wash as needed after the preliminary cold rolling. Preferably, the method includes annealing and/or acid wash after the preliminary cold rolling. The titanium sheet stock after the preliminary cold rolling preferably bears no impurities deposited on the surface and includes a recrystallized structure. The lower limit of the thickness of the titanium sheet stock is typically about 0.2 mm, and preferably about 0.3 mm, and the upper limit thereof is typically about 1 mm, and preferably about 0.8 mm.

The titanium sheet according to the present invention including the compound-mixed titanium layer formed by the specific cold rolling as above may be subjected sequentially to press forming as needed to form an appropriate surface profile such as channels or grooves and to formation of an electroconductive layer on the surface. Thus, the titanium sheet can be used as a separator. The electroconductive layer is exemplified by carbonaceous layers such as diamond-like carbonaceous layers; and noble metal layers. Examples of the noble metal include Ru, Rh, Pd, Os, Ir, Pt, and Au.

The present application claims priority to Japanese Patent Application No. 2013-67376 filed on Mar. 27, 2013. The entire contents of Japanese Patent Application No. 2013-67376 filed on Mar. 27, 2013 are incorporated herein by reference.

### Examples

The present invention will be illustrated in further detail with reference to several examples (experimental examples) below. It should be noted, however, that the examples are by no means intended to limit the scope of the invention; that various changes and modifications can naturally be made therein without deviating from the spirit and scope of the invention as described herein; and all such changes and modifications should be considered to be within the scope of the invention.

Industrial pure titanium sheets (JIS Grade 1) were subjected sequentially to preliminary cold rolling, vacuum annealing, and surface washing with nitric hydrofluoric acid and yielded titanium sheet stocks having a thickness of 0.30 mm or 0.50 mm and a width of 50 mm. The titanium sheet stocks were subjected to cold rolling using an ester rolling oil in pass schedules given in Tables 1 and 2 below. The cold rolling was performed using a four-high rolling mill with work rolls having a diameter of 30 mm, 50 mm, or 100 mm. The rolling rate was set at a constant rate of 100 m/min.

The resulting rolled workpieces were subjected to heat treatment (intermediate anneal) under conditions given in Table 3 below, then cooled down to retrieval temperatures given in Table 3, and retrieved into the air. The heat treatment was performed in argon gas having a dew point of −41° C., or performed after evacuating the system to a vacuum at an absolute pressure of 0.001 Pa and replacing the vacuum atmosphere with argon gas at a pressure of 90 kPa.

Properties of the resulting annealed samples were examined by following methods.

(1) Contact Resistance

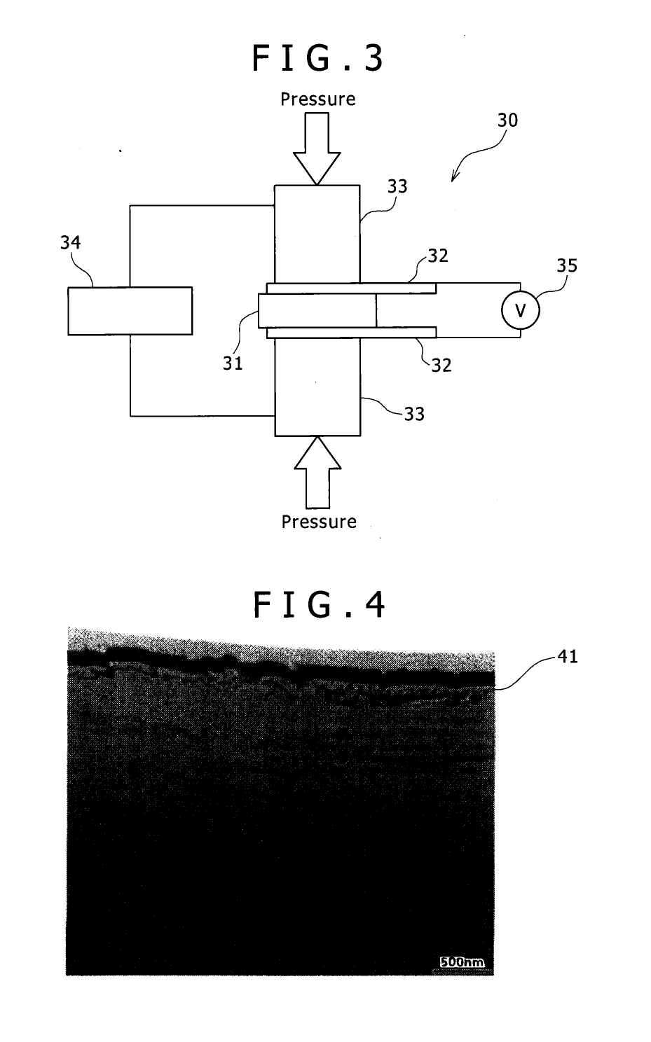

The contact resistance was examined using measurement equipment 30 as illustrated in FIG. 3. Specifically, a measurement sample (annealed sample) 31 was held at the both sides between a pair of carbon doth 32, the both sides of which were further held between a pair of copper electrodes 33 with a contact area of 100 mm², and a load of 98 N was applied. The copper electrodes 33 had gold foil applied at the tip. A direct current of 7.4 mA was applied from a power source 34, a voltage applied between the pair of carbon cloth 32 was measured with a voltmeter 35, and a resistance (contact resistance) generated by the sample (annealed sample) was determined.

(2) Microstructure

The measurement sample (annealed sample) was examined to observe the microstructure in a cross section perpendicular to the rolling direction with an optical microscope at 100-fold magnification, and the presence or absence of recrystallization was determined.

(3) Compound-Mixed Titanium Layer Thickness

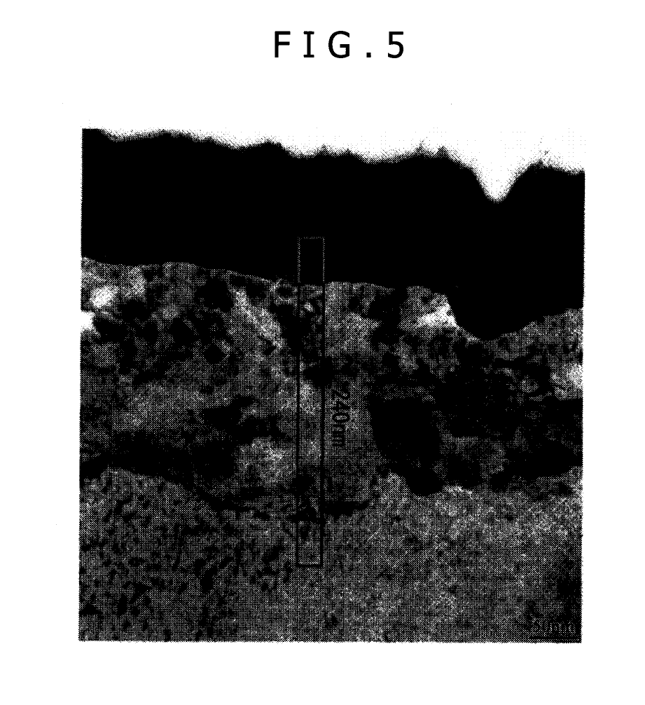

The measurement sample (annealed sample) was cut at the central part to expose a cross section. After vapor deposition of gold (Au) on the surface of the cross section, photomicrographs of the cross section were taken using a transmission electron microscope (TEM). FIG. 5 depicts an exemplary medium-magnification (500000-fold magnification) TEM photomicrograph; and FIG. 4 depicts an exemplary low-magnification (50000-fold magnification) TEM photomicrograph A black and gray spotted layer 41 near to the surface in the low-magnitude photomicrograph (FIG. 4) corresponds to the compound-mixed titanium layer. The thickness of the layer 41 was directly measured in the vertical direction as in the medium-magnification photomicrograph (FIG. 5).

(4) Passivation Layer Thickness

A high-magnification (5000000-fold magnification) TEM photomicrograph of the sample cross section was taken by the same procedure as in the measurement of the compound-mixed titanium layer thickness. A brightness profile in the passivation layer direction was plotted from a bright field image. Based on the bright field image, the profile was plotted in a width of about 2 nm when the passivation layer was determined to have a thickness of 10 nm or less; and the profile was plotted in a width of about 15 nm when the passivation layer was determined to have a thickness greater than 10 nm. With reference to the bright field image and based on the profile, positions corresponding to the half values of brightness changes respectively between the passivation layer and the oxide film and between the passivation layer and the base metal were identified as interfaces of the passivation layer, and the distance between the interfaces was defined as the thickness of the passivation layer.

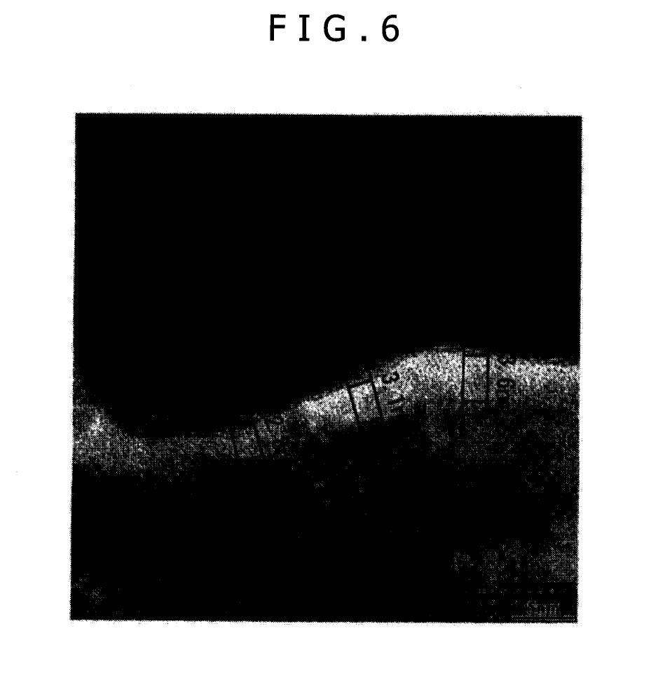

FIG. 6 depicts an exemplary high-magnification TEM photomicrograph. The high-magnification TEM photomicrograph is an enlarged view of a surface portion of the compound-mixed titanium layer 41 in the medium-magnification TEM photomicrograph of FIG. 5. The thickness of the passivation layer was directly measured in the thickness direction as in the high-magnification TEM photomicrograph (FIG. 6).

Results are indicated in Table 3.

TABLE 1

| | | Rolling pass schedule | | | | | | | | | | | | | | |
|---|---|---|---|---|---|---|---|---|---|---|---|---|---|---|---|---|
| | | Pass 1 | | | Pass 2 | | | Pass 3 | | | Pass 4 | | | Pass 5 | | |
| | | | | Corr- | | | Corr- | | | Corr- | | | Corr- | | | Corr- |
| | | | | espon- | | | espon- | | | espon- | | | espon- | | | espon- |
| | | | | dence to | | | dence to | | | dence to | | | dence to | | | dence to |
| | Sheet | Sheet | | pass- | Sheet | | pass- | Sheet | | pass- | Sheet | | pass- | Sheet | | pass- |
| | thick- | thick- | Con- | ivation | thick- | Con- | ivation | thick- | Con- | ivation | thick- | Con- | ivation | thick- | Con- | ivation |
| | ness | ness | tact | layer- | ness | tact | layer- | ness | tact | layer- | ness | tact | layer- | ness | tact | layer- |
| Test | before | after | arc | break- | after | arc | break- | after | arc | break- | after | arc | break- | after | arc | break- |
| Exam- | rolling | rolling | length | down | rolling | length | down | rolling | length | down | rolling | length | down | rolling | length | down |
| ple | (mm) | (mm) | (mm) | pass | (mm) | (mm) | pass | (mm) | (mm) | pass | (mm) | (mm) | pass | (mm) | (mm) | pass |
| 1 | 0.50 | | | | | | | | | | | | | | | |
| 2 | 0.30 | 0.228 | 1.04 | Corres. | 0.213 | 0.47 | | 0.199 | 0.46 | | 0.184 | 0.47 | | 0.169 | 0.47 | |
| 3 | 0.30 | 0.230 | 1.02 | Corres. | 0.180 | 0.87 | Corres. | 0.140 | 0.77 | Corres. | 0.125 | 0.47 | | 0.110 | 0.47 | |
| 4 | 0.50 | 0.405 | 1.19 | Corres. | 0.340 | 0.99 | Corres. | 0.280 | 0.95 | Corres. | 0.220 | 0.95 | Corres. | 0.160 | 0.95 | Corres. |
| 5 | 0.30 | 0.230 | 1.32 | Corres. | 0.213 | 0.65 | | 0.196 | 0.65 | | 0.180 | 0.63 | | 0.163 | 0.65 | |
| 6 | 0.30 | 0.231 | 1.31 | Corres. | 0.185 | 1.07 | Corres. | 0.155 | 0.87 | | 0.130 | 0.79 | | 0.114 | 0.63 | |
| 7 | 0.30 | 0.250 | 1.58 | Corres. | 0.226 | 1.10 | | 0.213 | 0.81 | | 0.200 | 0.81 | | 0.188 | 0.77 | |
| 8 | 0.50 | 0.410 | 2.12 | Corres. | 0.340 | 1.87 | Corres. | 0.280 | 1.73 | Corres. | 0.220 | 1.73 | Corres. | 0.159 | 1.75 | Corres. |
| 9 | 0.50 | 0.407 | 1.53 | Corres. | | | | | | | | | | | | |
| 10 | 0.50 | 0.483 | 0.65 | | 0.420 | 1.26 | Corres. | 0.410 | 0.50 | | 0.360 | 1.12 | Corres. | 0.345 | 0.61 | |
| 11 | 0.50 | 0.485 | 0.61 | | 0.470 | 0.61 | | 0.410 | 1.22 | Corres. | 0.360 | 1.12 | Corres. | 0.345 | 0.61 | |
| 12 | 0.50 | 0.409 | 1.51 | Corres. | 0.346 | 1.26 | Corres. | | | | | | | | | |
| 13 | 0.50 | 0.412 | 1.48 | Corres. | 0.340 | 1.34 | Corres. | 0.278 | 1.25 | Corres. | | | | | | |
| 14 | 0.50 | 0.410 | 1.50 | Corres. | 0.336 | 1.36 | Corres. | 0.281 | 1.17 | Corres. | 0.218 | 1.26 | Corres. | 0.161 | 1.19 | Corres. |
| 15 | 0.50 | 0.414 | 1.47 | Corres. | 0.341 | 1.35 | Corres. | 0.282 | 1.21 | Corres. | 0.220 | 1.25 | Corres. | 0.160 | 1.22 | Corres. |
| 16 | 0.50 | 0.410 | 1.50 | Corres. | 0.338 | 1.34 | Corres. | 0.283 | 1.17 | Corres. | 0.218 | 1.27 | Corres. | 0.162 | 1.18 | Corres. |
| 17 | 0.50 | 0.406 | 1.53 | Corres. | 0.343 | 1.26 | Corres. | 0.279 | 1.27 | Corres. | 0.220 | 1.21 | Corres. | 0.159 | 1.24 | Corres. |
| 18 | 0.50 | 0.413 | 1.48 | Corres. | 0.341 | 1.34 | Corres. | 0.278 | 1.26 | Corres. | 0.222 | 1.18 | Corres. | 0.158 | 1.27 | Corres. |
| 19 | 0.50 | 0.411 | 1.49 | Corres. | 0.342 | 1.31 | Corres. | 0.278 | 1.27 | Corres. | 0.220 | 1.20 | Corres. | 0.162 | 1.20 | Corres. |
| 20 | 0.50 | 0.408 | 1.52 | Corres. | 0.343 | 1.27 | Corres. | 0.283 | 1.22 | Corres. | 0.222 | 1.24 | Corres. | 0.163 | 1.21 | Corres. |
| 21 | 0.50 | 0.410 | 1.50 | Corres. | 0.341 | 1.31 | Corres. | 0.281 | 1.22 | Corres. | 0.220 | 1.24 | Corres. | 0.160 | 1.22 | Corres. |
| 22 | 0.50 | 0.408 | 1.52 | Corres. | 0.339 | 1.31 | Corres. | 0.279 | 1.22 | Corres. | 0.223 | 1.18 | Corres. | 0.162 | 1.24 | Corres. |
| 23 | 0.50 | 0.411 | 1.49 | Corres. | 0.342 | 1.31 | Corres. | 0.282 | 1.22 | Corres. | 0.220 | 1.25 | Corres. | 0.160 | 1.22 | Corres. |
| 24 | 0.50 | 0.406 | 1.53 | Corres. | 0.338 | 1.30 | Corres. | 0.280 | 1.20 | Corres. | 0.218 | 1.25 | Corres. | 0.158 | 1.22 | Corres. |

TABLE 2

| | | | | | | | | | | | | | Total | | |
|---|---|---|---|---|---|---|---|---|---|---|---|---|---|---|---|
| | Rolling pass schedule | | | | | | | | | | | | rolling | | |
| | Pass 6 | | | Pass 7 | | | Pass 8 | | | | | | reduc- | | |
| | | | Corr- | | | Corr- | | | Corr- | | | | tion | | |
| | | | espon- | | | espon- | | | espon- | | | | R of | | |
| | | | dence to | | | dence to | | | dence to | | | | pass- | Rolling | |
| | Sheet | | pass- | Sheet | | pass- | Sheet | | pass- | | | | ivation | reduc- | |
| | thick- | | ivation | thick- | | ivation | thick- | | ivation | Finish | Roll | Lmin | layer- | tion | |
| | ness | Contact | layer- | ness | Contact | layer- | ness | Contact | layer- | sheet | dia- | (=−20/ | break- | R of | |
| Test | after | arc | break- | after | arc | break- | after | arc | break- | thick- | meter | D + | down | all | |
| Exam- | rolling | length | down | rolling | length | down | rolling | length | down | ness | D | 1.35) | passes | passes | R/Rt |
| ple | (mm) | (mm) | pass | (mm) | (mm) | pass | (mm) | (mm) | pass | (mm) | (mm) | (mm) | (%) | (%) | (%) |
| 1 | | | | | | | | | | 0.50 | — | — | 0.0% | 0.0% | — |
| 2 | 0.155 | 0.46 | | 0.140 | 0.47 | | | | | 0.14 | 30 | 0.68 | 24.0% | 53.3% | 45.0% |
| 3 | 0.100 | 0.39 | | | | | | | | 0.10 | 30 | 0.68 | 53.3% | 66.7% | 80.0% |
| 4 | 0.123 | 0.75 | Corres. | 0.101 | 0.57 | | | | | 0.10 | 30 | 0.68 | 75.4% | 79.8% | 94.5% |
| 5 | 0.146 | 0.65 | | 0.129 | 0.65 | | 0.115 | 0.59 | | 0.12 | 50 | 0.95 | 23.3% | 61.7% | 37.8% |
| 6 | 0.100 | 0.59 | | | | | | | | 0.10 | 50 | 0.95 | 38.3% | 66.7% | 57.5% |
| 7 | 0.175 | 0.81 | | 0.163 | 0.77 | | 0.150 | 0.81 | | 0.15 | 100 | 1.15 | 16.7% | 50.0% | 33.3% |
| 8 | 0.126 | 1.28 | Corres. | 0.110 | 0.89 | | 0.103 | 0.59 | | 0.10 | 100 | 1.15 | 74.8% | 79.4% | 94.2% |
| 9 | | | | | | | | | | 0.41 | 50 | 0.95 | 18.6% | 16.6% | 100.0% |
| 10 | | | | | | | | | | 0.35 | 50 | 0.95 | 23.6% | 31.0% | 76.3% |
| 11 | 0.290 | 1.17 | Corres. | 0.275 | 0.61 | | | | | 0.28 | 50 | 0.95 | 35.6% | 45.0% | 79.1% |
| 12 | | | | | | | | | | 0.35 | 50 | 0.95 | 30.8% | 30.8% | 100.0% |
| 13 | | | | | | | | | | 0.28 | 50 | 0.95 | 44.4% | 44.4% | 100.0% |
| 14 | 0.124 | 0.96 | Corres. | | | | | | | 0.12 | 50 | 0.95 | 75.2% | 75.2% | 100.0% |
| 15 | 0.125 | 0.94 | | 0.101 | 0.77 | | | | | 0.10 | 50 | 0.95 | 68.0% | 79.8% | 85.2% |
| 16 | 0.126 | 0.95 | Corres. | 0.100 | 0.81 | | | | | 0.10 | 50 | 0.95 | 74.8% | 80.0% | 93.5% |
| 17 | 0.124 | 0.94 | | 0.099 | 0.79 | | | | | 0.10 | 50 | 0.95 | 68.2% | 80.2% | 85.0% |
| 18 | 0.125 | 0.91 | | 0.100 | 0.79 | | | | | 0.10 | 50 | 0.95 | 68.4% | 80.0% | 85.5% |
| 19 | 0.126 | 0.95 | Corres. | 0.099 | 0.82 | | | | | 0.10 | 50 | 0.95 | 74.8% | 80.2% | 93.3% |
| 20 | 0.137 | 0.81 | | 0.101 | 0.95 | Corres. | | | | 0.10 | 50 | 0.95 | 76.0% | 79.8% | 95.2% |
| 21 | 0.125 | 0.94 | | 0.100 | 0.79 | | | | | 0.10 | 50 | 0.95 | 66.0% | 80.0% | 85.0% |
| 22 | 0.124 | 0.97 | Corres. | 0.102 | 0.74 | | | | | 0.10 | 50 | 0.95 | 75.2% | 79.6% | 94.5% |
| 23 | 0.124 | 0.95 | Corres. | 0.101 | 0.76 | | | | | 0.10 | 50 | 0.95 | 75.2% | 79.8% | 94.2% |
| 24 | 0.125 | 0.91 | | 0.102 | 0.76 | | | | | 0.10 | 50 | 0.95 | 68.4% | 79.6% | 85.9% |

TABLE 3

| | | | | | | | | Com- |
|---|---|---|---|---|---|---|---|---|
| | | | | | | | | pound- |
| | | | | | Pass- | | | mixed |
| | Heat treatment | | | | ivation | | Contact | titanium |
| | | | | Retrieval | layer- | | resist- | layer |
| Test | | Temper- | | temper- | thick- | Micro- | tance | thick- |
| Exam- | | ature | Time | ature | ness | struc- | (mΩ · | ness |
| ple | Process | (°C.) | (min) | (°C.) | (nm) | ture | cm²) | (nm) |
| 1 | None | | | | 20.0 | Recrystallized | 45.0 | 0 |
| 2 | Ar | 700 | 1 | ≦100 | 8.6 | Recrystallized | 25.0 | 20 |
| 3 | Ar | 700 | 1 | ≦100 | 1.5 | Recrystallized | 7.5 | 70 |
| 4 | Ar | 700 | 1 | ≦100 | 0.0 | Recrystallized | 5.4 | 100 |
| 5 | Ar | 700 | 1 | ≦100 | 5.8 | Recrystallized | 22.5 | 20 |
| 6 | Ar | 700 | 1 | ≦100 | 1.9 | Recrystallized | 8.5 | 45 |
| 7 | Ar | 700 | 1 | ≦100 | 9.0 | Recrystallized | 24.5 | 60 |
| 8 | Ar | 700 | 1 | ≦100 | 0.3 | Recrystallized | 6.2 | 70 |
| 9 | Ar | 700 | 1 | ≦100 | 9.6 | Recrystallized | 27.3 | ≦500 |
| 10 | Ar | 700 | 1 | ≦100 | 8.3 | Recrystallized | 23.2 | ≦250 |
| 11 | Ar | 700 | 1 | ≦100 | 3.1 | Recrystallized | 12.8 | ≦100 |
| 12 | Ar | 700 | 1 | ≦100 | 3.6 | Recrystallized | 15.1 | ≦300 |
| 13 | Ar | 700 | 1 | ≦100 | 1.2 | Recrystallized | 8.6 | ≦100 |
| 14 | Ar | 700 | 1 | ≦100 | 0.0 | Recrystallized | 6.0 | 30-60 |
| 15 | Ar | 700 | 1 | ≦100 | 0.0 | Recrystallized | 5.4 | 30-60 |
| 16 | None | | | | 0.0 | As-rolled | 36.8 | 30-60 |
| | | | | | | (microstructure) | | |
| 17 | Ar | 350 | 1 | ≦100 | 0.0 | As-rolled | 20.2 | 30-60 |
| | | | | | | (microstructure) | | |
| 18 | Ar | 500 | 1 | ≦100 | 0.0 | Recrystallized | 6.8 | 30-60 |
| 19 | Ar | 800 | 1 | ≦100 | 2.1 | Recrystallized | 9.7 | 30-60 |
| 20 | Ar | 900 | 1 | ≦100 | 32.0 | Recrystallized | 68.0 | 30-60 |
| 21 | Ar | 700 | 1 | 350 | 6.2 | Recrystallized | 22.4 | 30-60 |
| 22 | Va | 400 | 1440 | ≦100 | 0.0 | Recrystallized | 7.5 | 30-60 |
| 23 | Va | 500 | 60 | ≦200 | 0.2 | Recrystallized | 6.5 | 30-60 |
| 24 | Va | 600 | 60 | ≦200 | 0.3 | Recrystallized | 5.9 | 30-60 |

In the table, “Ai” represents line annealing in an argon atmosphere; and “VA” represents vacuum annealing.

Test Example 1 was a material as acid-washed, underwent air oxidation to form a passivation layer, and had a high contact resistance. Test Examples 2, 5, 7, 9, and 10 underwent cold rolling at an insufficient total rolling reduction R of passivation-layer-breakdown pass(es) meeting the condition specified by Formula (1), underwent at least one of inappropriate passivation layer breakdown and inappropriate passivation layer regeneration restrainment by the compound-mixed titanium layer formation, included a large amount of remained passivation layer, and thereby had a high contact resistance. Test Examples 16 and 17 underwent insufficient intermediate anneal, failed to form a recrystallized structure, and had a high contact resistance due to a high resistance of the material itself. Test Example 20 underwent intermediate anneal performed at an excessively high heating temperature; whereas Test Example 21 was exposed to the air at an excessively high temperature. Both these examples bore a thick passivation layer and had a high contact resistance.

In contrast to these, Test Examples 3, 4, 6, 8, 11 to 15, 18 to 19, and 22 to 24 underwent cold rolling and intermediate anneal performed under appropriate conditions, could break down a passivation layer, formed a compound-mixed titanium layer to restrain the passivation layer from regenerating, thereby achieved stable reduction in thickness of the passivation layer, and could have a sufficiently lowered contact resistance.

The contact resistance was measured again three months later. As a result, Test Example 17 had a significantly increased contrast resistance of 30.4 mΩ·cm² (increased from 20.2 mg·cm²), whereas Test Example 14 had a contact resistance of 5.4 mΩ·cm² at much the same level as before (6.0 mΩ·cm²).

### INDUSTRIAL APPLICABILITY

The titanium sheet according to the present invention enables stable and significant reduction in thickness of the passivation layer and, when used in a fuel cell separator, can contribute to a significantly reduced contact resistance. The titanium sheet is therefore industrially very useful.

### REFERENCE SIGNS LIST

1 work roll
2 titanium material
30 contact resistance measurement equipment
31 measurement sample (annealed sample)
32 carbon doth
33 copper electrode
34 power source
35 voltmeter
41 compound-mixed titanium layer

1. A titanium sheet for fuel cell separators, the titanium sheet comprising:
a titanium base metal, and
a surface layer
wherein:
the titanium base metal comprises a recrystallized structure,
the surface layer comprises:
a compound-mixed titanium layer having a thickness of less than 1 μm, and
optionally a passivation layer having a thickness of less than 5 nm and being disposed on a surface of the compound-mixed titanium layer;
the compound-mixed titanium layer comprises a mixture of:
a matrix titanium (Ti) comprising oxygen (O), carbon (C), and nitrogen (N) that is each solid-soluted in the matrix; and
a compound comprising Ti and at least one element selected from the group consisting of O, C, and N.

2. The titanium sheet according to claim 1,
wherein the titanium sheet has a thickness from 0.02 to 0.4 mm.

3. The titanium sheet according to claim 1,
wherein the compound-mixed titanium layer has a thickness of 10 nm or more.

4. The titanium sheet according to claim 1,
wherein the titanium sheet has a contact resistance of 20.0 mΩ·cm² or less.

5. A method for producing titanium sheet according to claim 1, the method comprising:
cold-rolling an annealed titanium sheet stock using an organic rolling oil to give a cold-rolled workpiece, and
subjecting the cold-rolled workpiece to a heat treatment to produce the titanium sheet,
wherein:
when a rolling pass meets a condition specified by Formula (1) and is referred to as a passivation-layer-breakdown pass, the cold rolling comprises a single-stage or multi-stage pass schedule comprising one or more of the passivation-layer-breakdown passes,
a total rolling reduction R of all the passivation-layer-breakdown passes, as calculated by Formula (2), is 25% or more,
in the heat treatment, the cold-rolled workpiece is heated at a temperature of from 400° C. to 870° C. in an inert gas or in a vacuum to undergo recrystallization and then cooled down to a temperature of 300° C. or lower before being exposed to air,
Formulae (1) is expressed as:
L≧−20/D+1.35 (1)
where:
L represents a length (mm) of a contact portion between a rolling work roll and the titanium workpiece to be rolled; and
D represents a diameter (mm) of the rolling work roll,
Formula (2) is expressed as:
R=(1−tₐ₁/t_{b1}×tₐ₂/t_{b2}×tₐ₃/t_{b3} . . . )×100 (2)
where:
tₐ₁ and t_{b1} represent sheet thicknesses respectively after and before rolling of a first passivation-layer-breakdown pass;
tₐ₂ and t_{b2} represent sheet thicknesses respectively after and before rolling of a second passivation-layer-breakdown pass; and
tₐ₃ and t_{b3} represent sheet thicknesses respectively after and before rolling of a third passivation-layer-breakdown pass,
a term of tₐₙ/t_{bn} (where n is an integer) in Formula (2) is repeated in a number (n) of the passivation-layer-breakdown pass(es),
the term of tₐₙ/t_{bn} in Formula (2) is present in a number of 1 or 2 respectively when the cold rolling comprises one or two passivation-layer-breakdown passes, and
the individual passivation-layer-breakdown passes do not have to be performed successively, but may be performed with the interposition of one or more rolling passes not meeting the condition specified by Formula (1).

6. A fuel cell separator comprising:
the titanium sheet according to claim 1 as a base metal; and
an electroconductive layer on or over a surface of the base metal.

7. The titanium sheet according to claim 2,
wherein the compound-mixed titanium layer has a thickness of 10 nm or more.

8. The titanium sheet according to claim 2,
wherein the titanium sheet has a contact resistance of 20.0 mΩ·cm² or less.

9. A method for producing titanium sheet according to claim 2, the method comprising:
cold-rolling an annealed titanium sheet stock using an organic rolling oil to give a cold-rolled workpiece, and
subjecting the cold-rolled workpiece to a heat treatment to produce the titanium sheet,
wherein:
when a rolling pass meets a condition specified by Formula (1) and is referred to as a passivation-layer-breakdown pass, the cold rolling comprises a single-stage or multi-stage pass schedule comprising one or more of the passivation-layer-breakdown passes,
a total rolling reduction R of all the passivation-layer-breakdown passes, as calculated by Formula (2), is 25% or more,
in the heat treatment, the cold-rolled workpiece is heated at a temperature of from 400° C. to 870° C. in an inert gas or in a vacuum to undergo recrystallization and then cooled down to a temperature of 300° C. or lower before being exposed to air,
Formulae (1) is expressed as:
L≧−20/D+1.35 (1)
where:
L represents a length (mm) of a contact portion between a rolling work roll and the titanium workpiece to be rolled; and
D represents a diameter (mm) of the rolling work roll,
Formula (2) is expressed as:
R=(1−tₐ₁/t_{b1}×tₐ₂/t_{b2}×tₐ₃/t_{b3} . . . )×100 (2)
where:
tₐ₁ and t_{b1} represent sheet thicknesses respectively after and before rolling of a first passivation-layer-breakdown pass;
tₐ₂ and t_{b2} represent sheet thicknesses respectively after and before rolling of a second passivation-layer-breakdown pass; and
tₐ₃ and t_{b3} represent sheet thicknesses respectively after and before rolling of a third passivation-layer-breakdown pass,
a term of tₐₙ/t_{bn} (where n is an integer) in Formula (2) is repeated in a number (n) of the passivation-layer-breakdown pass(es),
the term of tₐₙ/t_{bn} in Formula (2) is present in a number of 1 or 2 respectively when the cold rolling comprises one or two passivation-layer-breakdown passes, and
the individual passivation-layer-breakdown passes do not have to be performed successively, but may be performed with the interposition of one or more rolling passes not meeting the condition specified by Formula (1).

10. A fuel cell separator comprising:
the titanium sheet according to claim 2 as a base metal; and
an electroconductive layer on or over a surface of the base metal.

11. A fuel cell, comprising the titanium sheet according to claim 1 as a separator.

12. A fuel cell, comprising the titanium sheet according to claim 2 as a separator.
